(19) United States
(12) Patent Application Publication
(10) Pub. No.: US 2014/0137808 A1
(43) Pub. Date: May 22, 2014

(54) STRETCHABLE INSECT REPELLANT BAND

(71) Applicant: Simon J. WHITE, Ridgefield, CT (US)

(72) Inventor: Simon J. WHITE, Ridgefield, CT (US)

(21) Appl. No.: 13/787,337

(22) Filed: Mar. 6, 2013

Related U.S. Application Data
(60) Provisional application No. 61/727,214, filed on Nov. 16, 2012.

(51) Int. Cl. A01N 25/34

(52) U.S. Cl. CPC A01N 25/34
USPC 119/654; 424/403; 514/531; 514/521; 514/389; 514/461; 514/63; 514/417

(57) ABSTRACT

The present invention is directed to an insect repelling device that may serve as an effective barrier against ticks. The insect repelling device may include a band of technical fabric, with the fabric being very stretchable. The insect repelling device may be worn around the ankles, wrist or head. The insect repelling device may be worn in pairs on each ankle and/or wrist. The insect repelling device may have an open, tubular design and be made of a high performance, nylon/ polyester fabric, allowing a user to easily insert the foot or hand and fit the device around the ankle or wrist area. Each insect repelling device may be pre-treated with an insecticide or insect repellant, such as Permethrin. In use, the insect repellant device may be effective at preventing biting insects, such as ticks, from crawling onto the user, for example from crawling up the legs of the user.

### CROSS-REFERENCE TO RELATED APPLICATIONS

This application claims priority to U.S. Provisional Appl. No. 61/727,214 filed Nov. 16, 2012, which is hereby incorporated by reference in its entirety.

### BACKGROUND OF THE INVENTION

1. Field of the Invention

This invention relates to a wearable band that is configured to repel and/or kill insects, and more particularly to an insect repellant and/or insecticide stretchable band that can be worn around the ankles of a user to prevent insects, such as ticks, from crawling up the leg of the user, to prevent insects, such as ticks, from attaching to the skin, and to prevent the transfer of insect, such as tick, borne disease. The stretchable band can also be worn around the wrists and/or head of the user in order to provide an effective barrier against insects.

2. Description of Related Art

Biting insects or other insect pests may transmit and/or spread a variety of diseases. For example, a variety of infections may be borne by ticks. Studies have shown that of the variety of tick borne infections, Lyme disease is a first and major concern, and is the most common tick borne infection in the northern hemisphere. Millions are currently spent on the treatment of Lyme disease every year. Early symptoms of Lyme disease may include fever, headache, fatigue, depression, and a circular skin rash. Left untreated, later symptoms may involve the joints, heart, and central nervous system. To further illustrate the proliferation of Lyme disease, the Centers for Disease Control (CDC) reports that the ratio of Lyme disease infection is 7.9 cases for every 100,000 persons. In the ten states where Lyme disease is most common, the average was 31.6 cases for every 100,000 persons for the year 2010.

A variety of methods and devices may be used in order to repel and/or kill biting insects, such as ticks. For example, the U.S. Army is now treating their uniforms with an insecticide, and as a result cases of Lyme disease have significantly decreased. However, while wearing insecticide laden garments may be useful in repelling and/or killing biting insects, such as ticks, garments wore over the entire or most of the body may be cumbersome, expensive and/or not practical for all applications. Accordingly, what is needed is a versatile garment that can provide an effective barrier against biting insects, such as ticks, and thereby reduce the likelihood of contracting diseases borne by such insects, such as Lyme disease.

### SUMMARY OF THE INVENTION

The present invention contemplates the provision of an insect repelling device that can provide a versatile and effective barrier against biting insects and other insect pests.

It is an object of the present invention to provide a device that can provide a personal effective barrier against biting insects, such as ticks, or other pests.

It is another object of the present invention to provide a device that is comfortable to wear in order to provide an effective barrier against biting insects.

It is yet another object of the present invention to provide a device that can provide an effective barrier against biting insects while being safe to a wearer if worn for a prolonged period of time.

It is still another object of the present invention to provide a device that can provide an effective barrier against biting insects in order to eliminate and/or reduce the risk of infections caused and/or carrier by the biting insects, for example ticks.

It is yet another object of the present invention to provide a device that can provide an effective barrier against biting insects over an extended duration and multiple uses.

It is still another object of the present invention to provide a device that is easy to use and/or wear while still providing an effective barrier against biting insects, for example ticks.

It is yet another object of the present invention to provide a device that is capable of instantly repelling and/or killing any biting insect, or example ticks, that come into contact and/or proximity to the device in order to provide an effective barrier against biting insects.

It is yet another object of the present invention to provide a device that is configured to prevent biting insects from passing over and/or around the device in order to prevent the biting insects from entering farther onto the body of a user of the device.

It is yet another object of the present invention to provide a device that can be used during extended period outdoors in order to provide an effective barrier against biting insects.

It is still another object of the present invention to provide a device that can be safely used and/or worn by children, adults, pets and other animals in order to provide an effective barrier against biting insects, for example ticks.

It is still another object of the present invention to provide a device that can be beneficial to the health of individuals and/or animals by providing an effective barrier against biting insects.

It is yet another object of the present invention to provide a device that can be configured in a variety of sizes and shapes so as to permit use in a variety of applications in order to provide an effective barrier against biting insects, for example ticks.

It has now been found that the foregoing and related objects can be readily attained in an exemplary embodiment of the present invention directed to an insect repelling device that includes a stretchable tube dimensioned for application over at least one extremity of a user, the stretchable tube may be made from at least one fabric treated with at least one insecticide, and the at least one insecticide includes at least one pyrethriod.

In according with the exemplary embodiment of the present invention, the stretchable tube is formed from a continuous piece of the at least one fabric.

In according with the exemplary embodiment of the present invention, the stretchable tube may include an exterior surface and an interior region thereof, and the at least one fabric may include a first fabric treated with the at least one insecticide extending around the exterior surface of the stretchable tube and a second fabric positioned between the first fabric and the interior region of the stretchable tube.

In according with the exemplary embodiment of the present invention, the stretchable tube may include a first end, a second end and a passageway defined between the first end and the second end, and the insect repelling device is configured for application over the at least one extremity of the user by inserting a terminal portion of the at least one extremity into the first end and through the passageway to the second end.

In according with the exemplary embodiment of the present invention, the pyrethriod is selected from the group consisting of Allethrin, Bifenthrin, Cyfluthrin, Cypermethrin, Cyphenothrin, Deltamethrin, Esfenvalerate, Fenpropathrin, Fenvalerate, Flucythrinate, Imiprothrin, lambda-Cyhalothrin, Metofluthrin, Prallethrin, Permethrin, Resmethrin, Silafluofen, Sumithrin, tau-Fluvalinate, Tefluthrin, Tetramethrin, Tralomethrin, Transfluthrin or combinations thereof.

In according with the exemplary embodiment of the present invention, the pyrethriod is Permethrin.

In according with the exemplary embodiment of the present invention, the at least one fabric is further treated with at least one insect repellant.

In according with the exemplary embodiment of the present invention, the at least one fabric is comprised of cotton, rayon, linen, polyester, natural polyamide, synthetic polyamide, acrylic cellulose acetate, polyaramide, polypropylene, wool, silk or a blend of any of these.

In according with the exemplary embodiment of the present invention, the at least one fabric is comprised of a blend of polyester and cotton.

In according with the exemplary embodiment of the present invention, the at least one fabric is comprised of a blend of nylon and polyester.

In according with the exemplary embodiment of the present invention, the at least one fabric has wicking characteristics.

In according with the exemplary embodiment of the present invention, the at least one fabric has two-way stretch capability.

In according with the exemplary embodiment of the present invention, the at least one fabric has four-way stretch capability.

In according with the exemplary embodiment of the present invention, the at least one extremity of the user is a leg or an arm.

In according with the exemplary embodiment of the present invention, the user is a human user.

In according with the exemplary embodiment of the present invention, the user is an animal.

According to another exemplary embodiment of the present invention, a method of repelling insects is provided that may include providing a stretchable tube comprised of at least one fabric and dimensioned for application over at least one extremity of a user, and treating the at least one fabric of the stretchable tube with at least one insecticide, where the at least one insecticide comprises at least one pyrethriod.

In according with the exemplary embodiment of the present invention, the pyrethriod is selected from the group consisting of Allethrin, Bifenthrin, Cyfluthrin, Cypermethrin, Cyphenothrin, Deltamethrin, Esfenvalerate, Fenpropathrin, Fenvalerate, Flucythrinate, Imiprothrin, lambda-Cyhalothrin, Metofluthrin, Prallethrin, Permethrin, Resmethrin, Silafluofen, Sumithrin, tau-Fluvalinate, Tefluthrin, Tetramethrin, Tralomethrin, Transfluthrin or combinations thereof.

In according with the exemplary embodiment of the present invention, the pyrethriod is Permethrin.

The insect repelling device may serve as an effective barrier against ticks, and be worn around the ankles of the user whether the user is human or an animal. The insect repelling device may include a band of technical fabric manufactured from polyester and cotton, with the fabric being very stretchable. The insect repelling device may be worn around the ankles, wrist or head. The insect repelling device may be worn in pairs on each ankle and/or wrist. The insect repelling device may have an open, tubular design and be made of a high performance, nylon/polyester fabric, commonly found in athletic clothing, allowing a user to easily insert the foot or hand and fit the device around the ankle or wrist area.

Fabricated of a stretchable, performance-type fabric, the insect repelling device may preferably be approximately three inches (3″) in length and stretchable, but may be made available in a variety of sizes, including small, medium, large, and extra-large. The size of the insect repelling devices may be made to accommodate a variety of uses, for example children, pets, adults and animals, such as horses or livestock. The insect repelling device may also be of sufficient size and configuration to permit wearing it around the head as a bandana.

To offer fully optimized protection, each insect repelling device may be pre-treated with an insecticide or insect repellant, such as Permethrin. Permethrin is a common synthetic chemical that serves as a pesticide, and may even be capable of killing ticks upon contact with treated clothing. In use, the insect repellant device may be effective at preventing biting insects, such as ticks, from crawling onto the user, for example from crawling up the legs of the user.

### BRIEF DESCRIPTION OF THE SEVERAL VIEWS OF THE DRAWINGS

For a fuller understanding of the nature and object of the present invention, reference should be had to the following detailed description taken in connection with the accompanying drawings, in which:

FIG. 1 is a plan view of an exemplary embodiment of a repellant band according to the present invention;

FIG. 2 is a side view of the exemplary embodiment of the repellant band according to the present invention;

FIG. 3 is a perspective view of the exemplary embodiment of the repellant band according to the present invention;

FIG. 4 shows an exemplary embodiment of a repellant band according to the present invention worn on a user's leg; and

FIG. 5 shows an exemplary embodiment of a repellant band according to the present invention worn on a dog's leg.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

Referring now to FIGS. 1-3, therein illustrated is an exemplary embodiment of an insect repellant band, generally indicated by reference numeral 10, according to the present invention. The insect repellant band 10 may be formed from a stretchable tube 12 that may have a substantially cylindrical shape. The tube 12 may have a first end 14 and a second end 16 of a cylindrical sidewall 18 formed by the tube 12. The cylindrical sidewall 18 defines a passageway 20 formed in the tube 12 and extending from the first end 14 to the second end 16. The tube 12 may also include an exterior surface 22 extending around the outside of the cylindrical sidewall 18, and an interior surface 24 extending around the inside of the cylindrical sidewall 18 and facing the passageway 20 of the tube 12.

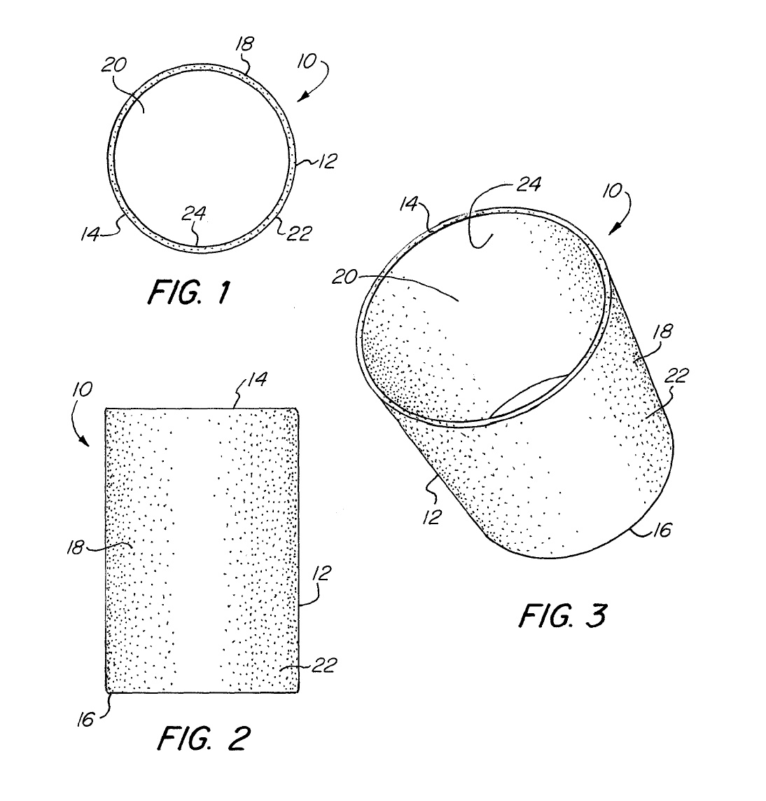

It is understood that the insect repellant band 10 may be formed from a continuous tube 12 or that the tube 12 may be formed by joining ends (not shown) formed in the insect repellant band 10 substantially perpendicular to the first end 14 and the second end 16 together. It is also understood that while the exterior surface 22 and interior surface 24 are specifically identified as “interior” and “exterior” it is contemplated that the insect repellant band 10 may be reversible, and therefore it is possible that the interior surface 24 may become the exterior surface 22 and vice versa. Accordingly, it is understood that the terms “interior” and “exterior” are merely used for reference, and are not intended to limit the present invention in any manner. It is further understood that while the insect repellant band 10 is shown in an at least partially expanded configuration in FIGS. 1-3, the insect repellant band 10 may have any configuration such that the passageway 20 formed through the tube 12 is in a collapsed and/or partially collapsed configuration. For example, the insect repellant band 10 may be laid flat on a surface (not shown) so that from the side it appears as in FIG. 2. It is also understood that the insect repellant band 10 may include one or more extensions and/or flares (not shown) extending from the first end 14 and/or second end 16 and towards the passageway 20 and/or away from the exterior surface 22 of the tube 12.

The insect repellant band 10 may be made from any fabric and/or textile, for example, cotton, rayon, linen, polyester, natural and synthetic polyamides, acrylic cellulose acetate, polyaramide, polypropylene fabrics, wool, silk or any blend of these. Preferably, the insect repellant band 10 may be made from a stretchable fabric and/or textile, and the fabric and/or textile used to form the insect repellant band 10 may have either 2-way or 4-way stretching capability. It is understood that stretchable fabric and/or textile includes, but not limited to, fabric and/or textiles that are capable of being urged in at least on direction along the plane of the fabric and/or textile so that the fabric and/or textile is expanded from its rest dimension. Even more preferably, the insect repellant band 10 may be made from a technical fabric manufactured from a combination of polyester and cotton that is very stretchable. The insect repellant band 10 may also be made from a performance fabric formed from nylon (synthetic polyamide) and polyester that is stretchable and may commonly be found in athletic clothing. It is understood that these fabrics or any other fabric and/or textiles used to form the insect repellant band 10 may have moisture wicking and/or odor neutralizing characteristics. It is further understood that the insect repellant band 10 may be made from a combination of different types of fabrics and/or textiles. For example, the tube 12 of the insect repellant band 10 may be made from two or more different types of fabrics and/or textiles so that the exterior surface 22 is formed from one type of fabric and/or textile and the interior surface 24 is formed from a second type of fabric and/or textile. It is also understood that the tube 12 of fabric and/or textile used to form the insect repellant band 10 may be may be dyed and/or colored to have any particular color, design and/or print so as to provide an attractive physical appearance for the insect repellant band 10. In order to provide insect repellant and/or insecticide capability to the insect repellant band 10, the insect repellant band 10 may be treated and/or impregnated with one or more insect repellants or insecticides. For example, a pyrethriod, such as Permethrin, may be used to treat and/or impregnate the insect repellant band 10. Pyrethriods, including both the naturally-occurring compounds and third synthetically prepared analogs can effectively control a variety of pests, such as ticks, cockroaches, houseflies, mosquitoes, black flies, fleas and other flying and crawling insects. In general, pyrethroids are not harmful to plants, food, animals or humans, and leave no harmful residues. Permethrin is a synthetic pyrethriod that exhibits insect repellant, knockdown and kill activity against a variety of insects. For example, Permethrin can be applied to fabrics in order to repel, resist and/or kill mosquitoes, ticks, fleas, bedbugs, chiggers and flies. It is understood that other pyrethroids, such as Allethrin, Bifenthrin, Cyfluthrin, Cypermethrin, Cyphenothrin, Deltamethrin, Esfenvalerate, Fenpropathrin, Fenvalerate, Flucythrinate, Imiprothrin, lambda-Cyhalothrin, Metofluthrin, Prallethrin, Resmethrin, Silafluofen, Sumithrin, tau-Fluvalinate, Tefluthrin, Tetramethrin, Tralomethrin, Transfluthrin or combinations thereof may also be used with the present invention. Additional insecticides that may be used for the present invention include, but are not limited to, organochlorides, such as dieldrin, endosulfan and heptachlor, organophosphates, such as acephate, dichlorvos and malathion, carbamates, such as bendiocarb, carbofuran and methomyl, neonicontinodes, such as acetamiprid, nitenpyram and thiacloprid, ryanoids, such as ryanxypyr, plant derived insecticides and/or biological insecticides. Exemplary insect repellants that may be used with the present invention include, but are not limited to, Birch tree bark, DEET (N,N-diethyl-m-toluamide), essential oil of the lemon eucalyptus, Icaridin, Nepetalactone, Citronella oil, Neem oil, Bog Myrtle, Dimethyl carbate, Tricyclodecenyl allyl ether, 3-[N-Butyl-N-acetyl]-aminopropionic acid, ethyl ester or combinations thereof.

The insect repellant band 10 may be treated and/or impregnated with Permethrin or any other insect repellant or insecticide in accordance with any known method as understood to one of ordinary skill in the art. For example, the insect repellant band 10 may be treated in accordance with the method of fabric treatment discussed in U.S. Appl. No. 2010/0261396, which is hereby incorporated by reference in its entirety. Permethrin has been approved by the Food and Drug Administration (FDA) as being safe for direct contact with the skin. During manufacture of the insect repellant band 10, the fabric and/or textile forming the insect repellant band 10 may be treated with Permethrin or other similar insecticide, Permethrin is preferred since it is highly effective at repelling and killing ticks, and is already approved by the FDA as a “safe” product against the skin for prolonged time. In addition, the treatment of the fabric with Permethrin may be effective for at least 70 washes, thereby ensuring a prolonged use life of the insect repellant band 10. It is also understood that at least one fragrance may be included in the insect repellant band 10 in order to provide a pleasant odor for the insect repellant band 10, and assist in masking any unpleasant odors that may emanate from the insect repellant band 10 as a result of the insect repellant or insecticide that has been used to treat and/or impregnate the insect repellant band 10.

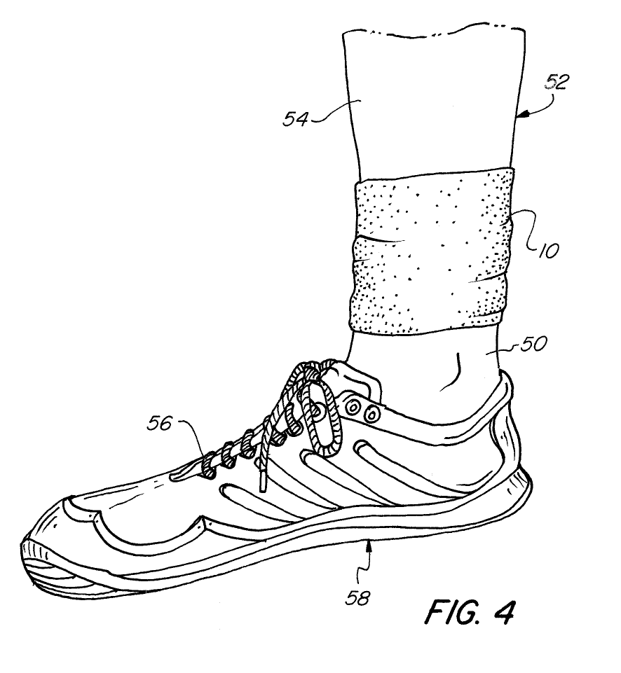

Referring now to FIG. 4, an exemplary use and application of the insect repellant band 10 will now be discussed. As shown in FIG. 4, the insect repellant band 10 may be worn around an ankle 50 of a user 52. When worn in this manner, the insect repellant band 10 can prevent biting insects, such as ticks, from crawling up the leg 54 of the user 52 and provides an effective barrier against biting insects as a result of the insect repellant band 10 being treated and/or impregnated with an insect repellant and/or insecticide. It is understood that the insect repellant band 10 may also be worn around the wrists (not shown), head (not shown) and or neck (not shown), or at any other suitable location on the body (not shown) of the user 52 in order to provide an effective barrier against biting insects. In order to apply the insect repellant band 10 to the ankle 50 of the user 52, the insect repellant band 10 is stretched an appropriate amount so as to extend around a foot 56 of the user 52, which may or may not include a shoe 58 and then placed in the desired location around the ankle 50 of the user 52. The insect repellant band 10 may be applied to the wrist and/or head in the same manner. The insect repellant band 10 may then be removed by pulling the insect repellant band 10 away from the ankle 50 of the user 52. The insect repellant band 10 may be washed and/or reused at a later time once removed from the user 52.

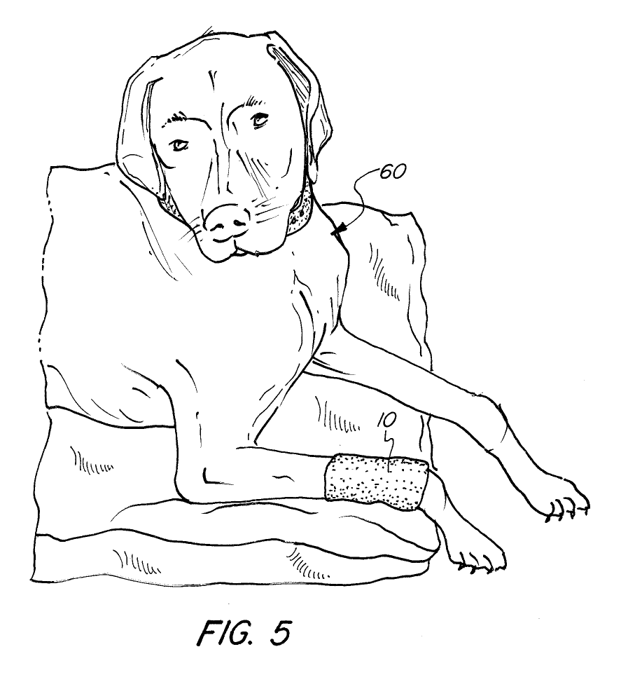

The insect repellant band 10 has a variety of uses and applications. For example, the insect repellant band 10 may be worn by a user while participating in outdoor sports, such as hiking, walking, running and/or climbing. The insect repellant band 10 may also be worn by a user while performing their occupation or duties, for example the insect repellant band 10 may be worn by gardeners, landscapers, tree service personnel, forestry workers, state and national park employees. The insect repellant band 10 may also be used by expedition companies or children's outdoor camp organizations. It is understood that the insect repellant band 10 may also be worn by pets, for example a dog 60 as shown in FIG. 5, or other animals, e.g. livestock, that it is desirable to prevent biting insects, such as ticks, from contacting and or crawling upon.

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

1. An insect repelling device, comprising:
a stretchable tube dimensioned for application over at least one extremity of a user,
wherein the stretchable tube is treated with at least one insecticide over its entirety and comprised of at least one fabric that has four-way stretch capability, and
wherein the at least one insecticide comprises at least one pyrethriod.

2. The insect repelling device according to claim 1, wherein the stretchable tube is formed from a continuous piece of the at least one fabric.

3. The insect repelling device according to claim 1, wherein the stretchable tube comprises an exterior surface and an interior region thereof, wherein the at least one fabric comprises a first fabric extending around the exterior surface of the stretchable tube and a second fabric positioned between the first fabric and the interior region of the stretchable tube, and wherein the first fabric and the second fabric are treated with the at least one insecticide.

4. The insect repelling device according to claim 1, wherein the stretchable tube comprises a first end, a second end and a passageway defined between the first end and the second end, and wherein the insect repelling device is configured for application over the at least one extremity of the user by inserting a terminal portion of the at least one extremity into the first end and through the passageway to the second end.

5. The insect repelling device according to claim 1, wherein the pyrethriod is selected from the group consisting of Allethrin, Bifenthrin, Cyfluthrin, Cypermethrin, Cyphenothrin, Deltamethrin, Esfenvalerate, Fenpropathrin, Fenvalerate, Flucythrinate, Imiprothrin, lambda-Cyhalothrin, Metofluthrin, Prallethrin, Permethrin, Resmethrin, Silafluofen, Sumithrin, tau-Fluvalinate, Tefluthrin, Tetramethrin, Tralomethrin, Transfluthrin or combinations thereof.

6. The insect repelling device according to claim 1, wherein the pyrethriod is Permethrin.

7. The insect repelling device according to claim 1, wherein the stretchable tube is further treated with at least one insect repellant over its entirety.

8. The insect repelling device according to claim 1, wherein the at least one fabric is comprised of cotton, rayon, linen, polyester, natural polyamide, synthetic polyamide, acrylic cellulose acetate, polyaramide, polypropylene, wool, silk or a blend of any of these.

9. The insect repelling device according to claim 1, wherein the at least one fabric is comprised of a blend of polyester and cotton.

10. The insect repelling device according to claim 1, wherein the at least one fabric is comprised of a blend of nylon and polyester.

11. The insect repelling device according to claim 1, wherein the at least one fabric has wicking characteristics.

12. (canceled)

13. (canceled)

14. The insect repelling device according to claim 1, wherein the at least one extremity of the user is a leg.

15. The insect repelling device according to claim 1, wherein the user is a human user.

16. The insect repelling device according to claim 1, wherein the user is pet animal or a livestock animal.

17. A method of repelling insects, comprising:
providing a stretchable tube comprised of at least one fabric that has four-way stretch capability and dimensioned for application over at least one extremity of a user, and
treating the stretchable tube with at least one insecticide over its entirety, and
wherein the at least one insecticide comprises at least one pyrethriod.

18. The method of repelling insects according to claim 17, wherein the pyrethriod is selected from the group consisting of Allethrin, Bifenthrin, Cyfluthrin, Cypermethrin, Cyphenothrin, Deltamethrin, Esfenvalerate, Fenpropathrin, Fenvalerate, Flucythrinate, Imiprothrin, lambda-Cyhalothrin, Metofluthrin, Prallethrin, Permethrin, Resmethrin, Silafluofen, Sumithrin, tau-Fluvalinate, Tefluthrin, Tetramethrin, Tralomethrin, Transfluthrin or combinations thereof.

19. The method of repelling insects according to claim 17, wherein the pyrethriod is Permethrin.

20. The insect repelling device according to claim 1, wherein the at least one extremity of the user is an arm or a head.

21. The insect repelling device according to claim 1, wherein the stretchable tube is treated with the at least one insecticide so that the stretchable tube maintains an effect amount of the at least one insecticide after at least fifty washings.

22. The insect repelling device according to claim 4, wherein the stretchable tube further comprises at least one flare extending from at least the first end or the second end in a direction non-parallel with the passageway of the stretchable tube.
